(19) United States
(12) Patent Application Publication
(10) Pub. No.: US 2016/0034405 A1
(43) Pub. Date: Feb. 4, 2016

(54) HETEROGENEOUS MEMORY SYSTEM AND DATA COMMUNICATION METHOD IN THE SAME

(71) Applicant: Electronics and Telecommunications Research Institute, Daejeon (KR)

(72) Inventors: Hyuk Je KWON, Daejeon (KR); Yong Seok CHOI, Daejeon (KR)

(21) Appl. No.: 14/813,916

(22) Filed: Jul. 30, 2015

(30) Foreign Application Priority Data
Jul. 30, 2014 (KR) 10-2014-0097427

(51) Int. Cl. G06F 13/16; G06F 13/42

(52) U.S. Cl. CPC G06F 13/1668; G06F 13/4282

(57) ABSTRACT

Provided are a heterogeneous memory system and a data communication method in the same. The heterogeneous memory system includes a plurality of different kinds of memory cells, and a central processing unit (CPU) configured to communicate with each of the plurality of memory cells using a high-speed serial link technique. The CPU includes a CPU protocol engine that generates and packetizes command data to be transmitted to at least one of the plurality of memory cells, and each of the plurality of memory cells include a memory protocol engine configured to analyze the command data received from the CPU, and a memory controller configured to perform the corresponding operation according to the analysis result in the memory protocol engine.

### CROSS-REFERENCE TO RELATED APPLICATION

This application claims priority to and the benefit of Korean Patent Application No. 10-2014-0097427, filed on Jul. 30, 2014, the disclosure of which is incorporated herein by reference in its entirety.

### BACKGROUND

1. Field of the Invention

The present invention relates to a heterogeneous memory system and a data communication method in the same, and more particularly, to a system that connects each of different kinds of memories and a central processing unit (CPU) using a high-speed serial link technique.

2. Discussion of Related Art

Systems, such as a computer system and a communication system, based on microprocessors identified as CPUs require main memories for data processing. General main memories are memories of the same kind and have the same capacity because it is easy for a CPU to control the memories.

Main memories are mainly formed of synchronous dynamic random access memories (SDRAMs), and double data rate 3 (DDR3) memories are most frequently used in recent years. SDRAMs have an advantage in that they are used most frequently among the same kind of memories and have a low price. On the other hand, SDRAMs have a long latency and a lower speed than flash memories, and are not non-volatile, such as phase-change RAM (PRAMs), but are volatile.

As communication speeds with a CPU are increased or memory access speeds increase in the process of improving a bandwidth, memory extension of existing DDR SDRAMs is limited. For example, it is not easy to increase memory channels because of the disposition and the alignment of signal lines for communication with a memory module in a mainboard.

Also, as a communication speed between DDR SDRAMs and a CPU increases, the number of dual in-line memory modules (DIMMs) which can be installed for each memory channel is gradually decreasing. Currently, a CPU has one or two memory channels, and it is possible to install a maximum of two DIMMs in the channels. However, when a memory access speed increases, the number of memory channels may be limited to one.

Further, in a system, such as an in-memory system, which has a high frequency of data processing and a high memory use frequency and requires a high capacity, it is not possible to cope with increases in speed and capacity using only DDR SDRAMS.

Therefore, it is necessary to develop a system in which different kinds of memories can be used by considering advantages of various memories and complementing disadvantages.

### SUMMARY OF THE INVENTION

The present invention is directed to providing a technological solution for installing different kinds of memories in one system and making it possible to use appropriate memories in situations requiring different functions.

According to an aspect of the present invention, there is provided a heterogeneous memory system including: a plurality of different kinds of memory cells; and a central processing unit (CPU) including a CPU protocol engine generating and packetizing command data to be transmitted to at least one of the plurality of memory cells, and configured to communicate with each of the plurality of memory cells using a high-speed serial link technique. Each of the plurality of memory cells include a memory protocol engine configured to analyze the command data received from the CPU; and a memory controller configured to perform an operation according to an analysis result in the memory protocol engine.

The heterogeneous memory system may further include a switch positioned among the plurality of memory cells and the CPU, connected to the CPU through one channel, and connected to the respective plurality of memory cells using the high-speed serial link technique, and any one of the plurality of memory cells may selectively perform data communication with the CPU through the switch.

The CPU and each of the plurality of memory cells may exchange data through a transceiver using optical communication.

The command data may include commands for the respective plurality of memory cells, data to be transmitted to the respective plurality of memory cells, and address information of the plurality of memory cells to which the commands or the data will be transmitted.

The CPU may further include a CPU-side de/serializer configured to serialize the command data packetized by the CPU protocol engine and deserialize response data received from the at least one memory cell.

The memory protocol engine may divide the command data received from the CPU into a control signal and a data signal.

When the command data received from the CPU is a read command, the memory protocol engine may packetize response data to be transmitted to the CPU according to the read command.

When data retransmission is requested by the CPU, the memory protocol engine may retransmit the response data having been previously transmitted and stored in a retransmission buffer to the CPU.

Each of the plurality of memory cells may further include a memory-side de/serializer configured to serialize data to be transmitted to the CPU and deserialize the command data received from the CPU.

According to another aspect of the present invention, there is provided a data communication method between a CPU and any one memory cell among a plurality of different kinds of memory cells in a heterogeneous memory system in which each of the plurality of different kinds of memory cells and the CPU communicate using a high-speed serial link technique, the data communication method including: transmitting, by the CPU, packetized command data to the one memory cell; analyzing, by the memory cell, the received command data; and performing, by the memory cell, an operation according to an analysis result of the command data.

The transmitting of the packetized command data by the CPU may include transmitting, by the CPU, the packetized command data to the one memory cell through a switch positioned among the plurality of memory cells and the CPU, connected to the CPU through one channel, and connected to the respective plurality of memory cells using the high-speed serial link technique.

The data communication method may further include generating, by the CPU, the command data including commands for the respective plurality of memory cells, data to be transmitted to the respective plurality of memory cells, and address information of the plurality of memory cells to which the commands or the data will be transmitted.

The transmitting of the packetized command data by the CPU may include: generating and packetizing the command data including information on the memory cell with which communication will be performed; serializing the packetized command data; and transmitting the serialized command data to the memory cell through a switch.

The analyzing of the received command data by the memory module may include: deserializing the command data received from the CPU; and analyzing the deserialized command data to divide the deserialized command data into a control signal and a data signal.

The performing of the operation according to the analysis result by the memory module may include: when the analysis result indicates that the command data is a read command, packetizing response data read according to the read command; serializing the packetized response data; and transmitting the serialized response data to the CPU through a switch.

The data communication method may further include: detecting, by the CPU, an error in response data received from the memory module; determining, by the CPU, whether or not it is necessary to receive the response data again according to a result of the error detection; when it is determined that it is necessary to receive the response data again, retransmitting, by the CPU, the previously transmitted command data to the memory module; and when the memory module receives the command data again, retransmitting the response data having been previously transmitted and then stored in a retransmission buffer to the CPU.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 shows an overall constitution of a heterogeneous memory system according to an exemplary embodiment of the present invention;

FIGS. 2A and 2B show examples of connections between different kinds of memory modules and a switch according to an exemplary embodiment of the present invention;

FIG. 3 is a block diagram showing detailed constitutions of a central processing unit (CPU) and a memory cell of a heterogeneous memory system according to an exemplary embodiment of the present invention;

FIG. 4 is a flowchart illustrating a data communication method in a heterogeneous memory system according to an exemplary embodiment of the present invention;

FIG. 5 is an operational flowchart of a CPU which generates and transmits command data in a heterogeneous memory system according to an exemplary embodiment of the present invention;

FIG. 6 is an operational flowchart of a memory cell which receives command data in a heterogeneous memory system according to an exemplary embodiment of the present invention; and

FIG. 7 is an operational flowchart of a CPU and a memory cell when a data retransmission request is generated of a heterogeneous memory system according to an exemplary embodiment of the present invention.

FIG. 8 is a block diagram illustrating a computer system for the present invention.

### DETAILED DESCRIPTION OF EXEMPLARY EMBODIMENTS

Advantages and features of the present invention and a method of achieving the same will be more clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. Meanwhile, the terminology used herein is for the purpose of describing the embodiments and is not intended to be limiting of the invention. As used in this specification, the singular form of a word includes the plural unless the context clearly indicates otherwise. The term “comprise” or “comprising,” when used herein, does not preclude the presence or addition of one or more components, steps, operations, and/or elements other than stated components, steps, operations, and/or elements.

Hereinafter, exemplary embodiments of the present invention will be described in detail with reference to the accompanying drawings. Throughout the specification, like reference numerals refer to like elements. In describing the present invention, any detailed description of known technology or function will be omitted if it is deemed that such a description will obscure the gist of the invention unintentionally.

A heterogeneous memory system manages data communication among a central processing unit (CPU) and a plurality of memory modules connected to the CPU on an operating system (OS). For example, the heterogeneous memory system manages a plurality of memory modules connected to a CPU using one memory map upon booting up (when the power is turned on) or periodically at a predetermined time unit.

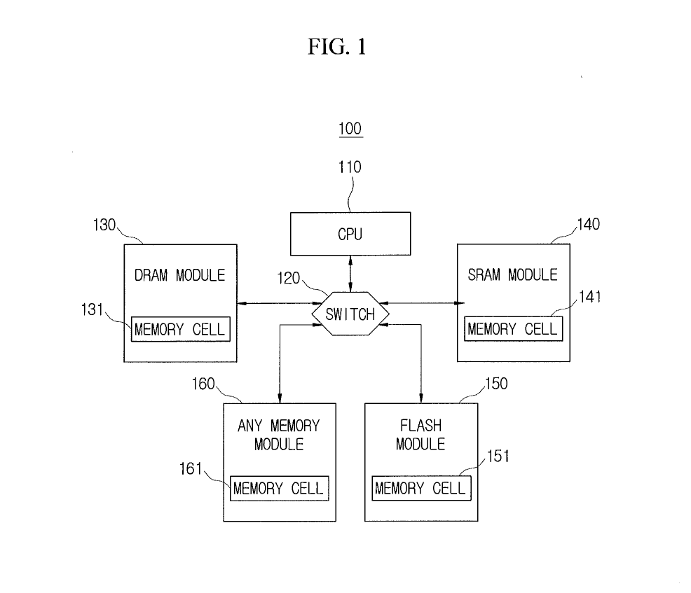

FIG. 1 shows an overall constitution of a heterogeneous memory system according to an exemplary embodiment of the present invention.

A heterogeneous memory system according to an exemplary embodiment of the present invention is a system that connects each of different kinds of memory modules 130 to 160 and a central processing unit (CPU) using a high-speed serial link technique through the switch 120. A heterogeneous memory system 100 according to an exemplary embodiment of the present invention includes a CPU 110, a plurality of different kinds of memory modules 130 to 160, and a switch 120 positioned among the plurality of memory modules 130 to 160 and the CPU 110.

The CPU 110 generates command data and packetizes the generated command data. The CPU 110 transmits the packetized command data to any one of the plurality of memory modules 130 to 160 through the switch. At this time, based on address information included in the command data, the command data transmitted from the CPU 110 may be finally transmitted to any one memory cell included in the memory module (e.g., the dynamic random access memory (DRAM) module 130).

The switch 120 and the CPU 110 may be connected through one channel. The switch 120 is connected to each of the plurality of different kinds of memory modules 130 to 160 using the high-speed serial link technique. For example, any one of the plurality of memory modules 130 to 160, more specifically, any one memory cell, may selectively perform data communication with the CPU 110 through the switch 120. At this time, based on address information included in data (command data) transmitted from the CPU 110, the switch 120 may be connected with the memory cell with which the CPU 110 tries to perform data communication.

The plurality of memory modules 130 to 160 are different kinds of memory modules that have different physical and electrical characteristics. In FIG. 1, the DRAM module 130, a static random access memory (SRAM) module 140, a flash module 150, and any memory module 160 of a different kind than the three memories are shown as the plurality of memory modules 130 to 160. However, a constitution of a heterogeneous memory system according to an exemplary embodiment of the present invention is not limited thereto, and other kinds of memory modules may be further included.

For convenience of description, a memory module with which the CPU 110 tries to perform data communication among the plurality of memory modules 130 to 160 is assumed below to be the DRAM module 130. Although not described in this specification, the data communication method in a heterogeneous memory system according to an exemplary embodiment of the present invention can also be applied to the other memory modules 140 to 160.

As an example, each of the plurality of memory modules 130 to 160 may be a module including one memory cell. In this case, the CPU 110 may be directly connected to one memory cell included in a memory module (DRAM module 130) with which data communication will be performed among the plurality of memory modules 130 to 160 through the switch 120.

As another example, each of the plurality of memory modules 130 to 160 may include a plurality of memory cells. For example, each of the plurality of memory modules 130 to 160 may be formed so that a plurality of memory cells are mounted on a circuit board. Here, each memory module may be a single inline memory module (SIMM) or a dual inline memory module (DIMM).

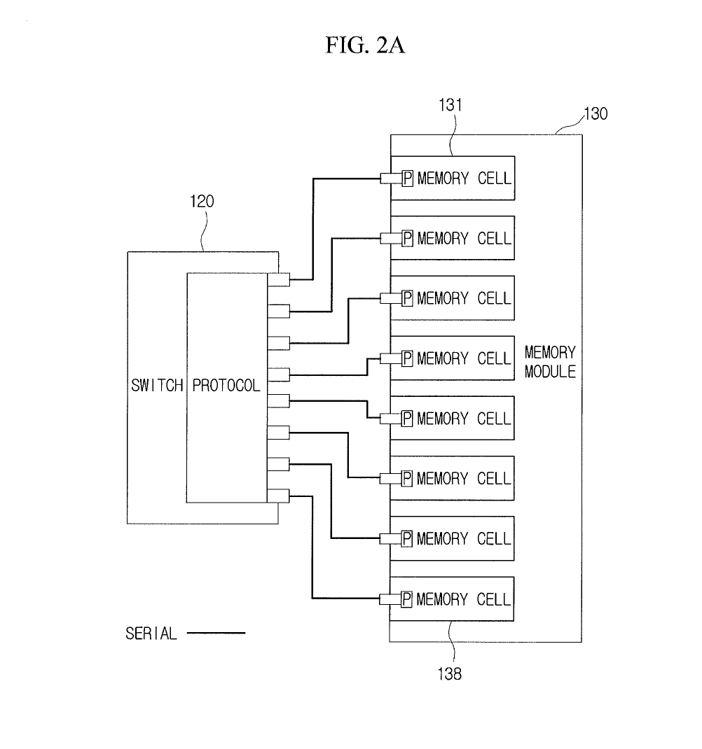

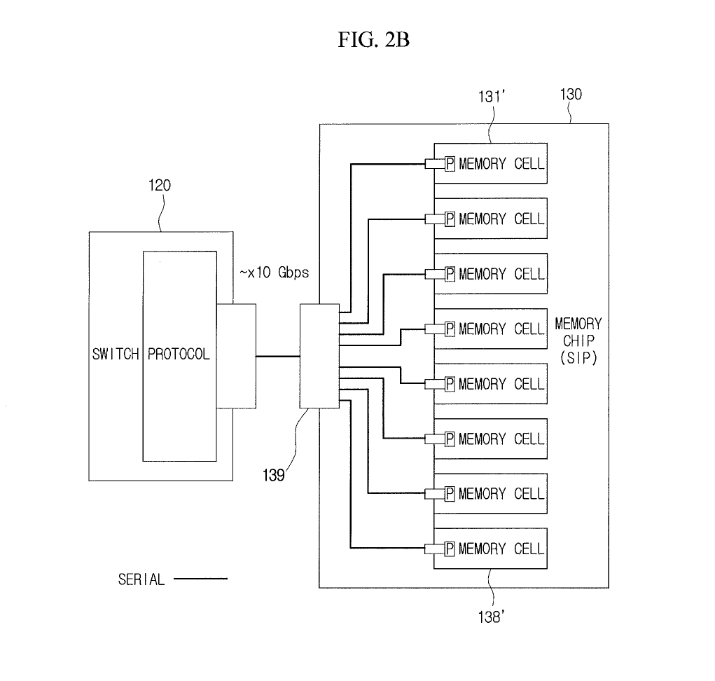

A connection relationship between the switch 120 and the DRAM module 130 including a plurality of memory cells are shown in FIG. 2 by way of example.

FIGS. 2A and 2B show examples of connections between different kinds of memory modules and a switch according to an exemplary embodiment of the present invention.

As an example, each of a plurality of memory cells 131 to 138 included in the DRAM module 130 and the switch 120 may be directly connected through an individual line as shown in referring to FIG. 2A.

As another example, the DRAM module 130 and the switch 120 are connected through one channel by a transceiver 139 implemented in the DRAM module 130, and a plurality of lines diverging from the transceiver 139 are connected to a respective plurality of memory cells 131′ to 138′ as shown in referring to FIG. 2B.

Through the connection structures shown in FIG. 2, data communication may be performed between each of the plurality of memory cells 131 to 138 or 131′ to 138′ included in the DRAM module 130 and the CPU 110.

Meanwhile, any one memory cell (e.g., the memory cell 131 included in the DRAM module 130) that receives command data from the CPU 110 analyzes the received command data and performs the corresponding operation according to the analysis result.

For example, when the received command data is a read command, the memory cell 131 packetizes response data read from a storage element and transmits the packetized response data to the CPU 110 through the switch 120 according to the read command.

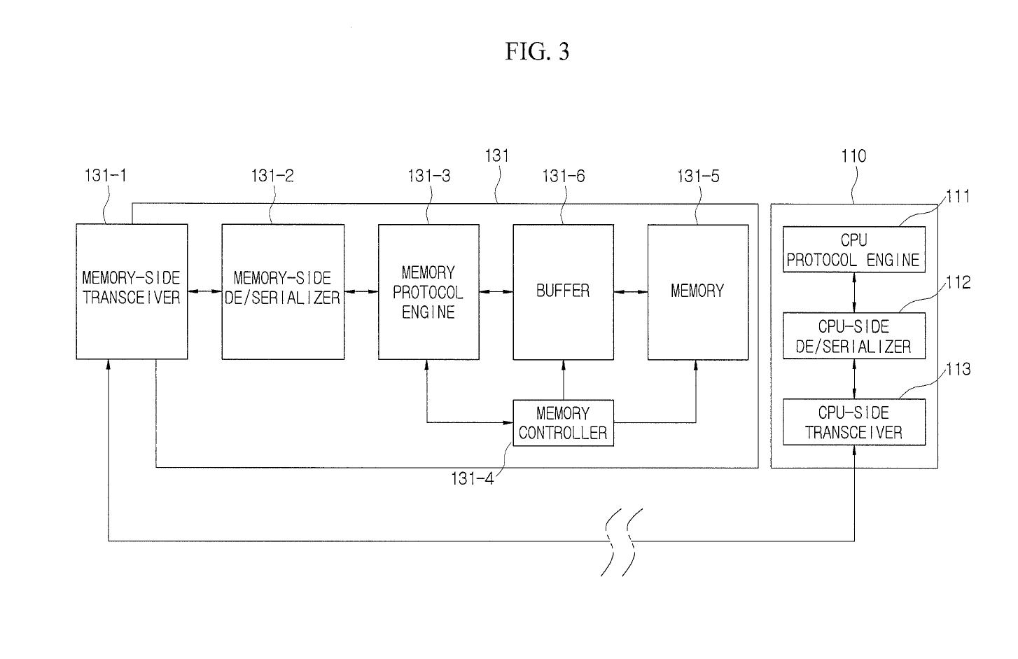

Detailed constitutions of a CPU and a memory cell according to an exemplary embodiment of the present invention will be described below with reference to FIG. 3.

FIG. 3 is a block diagram showing detailed constitutions of a CPU and a memory cell according to an exemplary embodiment of the present invention.

As shown in FIG. 3, the CPU 110 includes a CPU protocol engine 111, a CPU-side de/serializer 112, and a CPU-side transceiver 113.

The memory cell 131 includes a memory-side transceiver 131-1, a memory-side de/serializer 131-2, a memory protocol engine 131-3, a memory controller 131-4, a memory 131-5, and a buffer 131-6.

The CPU protocol engine 111 generates and packetizes command data to be transmitted to the memory cell 131. Here, the command data includes commands, data, and address information. For example, the CPU protocol engine 111 generates command information including commands for a respective plurality of memory cells, data to be transmitted to the respective plurality of memory cells, and address information of the memory cells to which the commands or the data will be transmitted.

The command data generated by the CPU protocol engine 111 is transmitted to the memory cell 131 using a packet communication method. To this end, the CPU protocol engine 111 packetizes the generated command data.

Also, the CPU protocol engine 111 analyzes data received from the memory cell 131 through the switch 120, thereby detecting and correcting an error. For example, when the CPU protocol engine 111 transmits command data, the memory cell 131 receiving the command data transmits response data corresponding to the command data back to the CPU protocol engine 111. At this time, the CPU protocol engine 111 analyzes the received response data, thereby detecting and correcting an error. For example, the CPU protocol engine 111 may detect an error in the response data using an error detection algorithm, such as a data parity check code or a cyclic redundancy check (CRC) code.

When an error is detected in the response data and retransmission of the data (response data) is necessary, the CPU protocol engine 111 requests data retransmission from the memory cell 131. When it is not possible to correct the error in the received response data, the CPU protocol engine 111 requests data retransmission from the memory cell 131 which has transmitted the response data. At this time, the CPU protocol engine 111 may request data retransmission from the memory cell 131 by retransmitting a previously transmitted packet (command data) to the memory cell 131. When an error is detected in the response data but it is possible to correct the error, the CPU protocol engine 111 may not request data retransmission.

The CPU-side de/serializer 112 serializes the data to be transmitted to the memory cell 131. For example, the CPU-side de/serializer 112 may be an interface integrated circuit (IC) that serializes the data (command data). Also, the CPU-side de/serializer 112 deserializes the data (response data) received from the memory cell 131.

The CPU-side transceiver 113 transmits the serialized command data to the switch 120. In this way, the CPU 110 may transmit the command data to the memory cell 131 connected to the switch 120.

As an example, the CPU-side transceiver 113 may be an optical element such as an optical fiber. For example, the CPU-side transceiver 113 may be optical silicon (Silicon Photonics). As another example, the CPU-side transceiver 113 may be an element that supports high-speed communication other than an optical element.

The command data transmitted in this way is transmitted to any one memory module (e.g., the DRAM module 130) among the plurality of memory modules 130 to 160 through the switch 120, and finally transmitted to any one memory cell included in the memory module. For example, the command data may be transmitted to the corresponding memory cell 131 (e.g., any one memory cell included in the DRAM module 130) based on the address information included in the command data.

At this time, the memory cell 131 receives the command data from the CPU 110 through the memory-side transceiver 131-1. Here, the memory-side transceiver 131-1 may be an optical element, such as an optical fiber (e.g., optical silicon), like the CPU-side transceiver 113.

The memory-side de/serializer 131-2 deserializes the command data received from the CPU 110 through the memory-side transceiver 131-1. Also, the memory-side de/serializer 131-2 serializes the data to be transmitted to the CPU 110. For example, the memory-side de/serializer 131-2 serializes the response data to be transmitted to the CPU 110 according to the command data.

The memory protocol engine 131-3 analyzes the command data received from the CPU 110. For example, the memory protocol engine 131-3 analyzes a packet of the command data deserialized by the memory-side de/serializer 131-2 as data, a command, an address, and so on. At this time, the memory protocol engine 131-3 may divide the command data into a control signal and a data signal, and analyze the control signal as a command, such as a read command, a write command, or a delete command. Also, the memory protocol engine 131-3 performs an operation of transferring the analyzed information to an internal logic (e.g., the memory controller 131-4) of the memory cell 131.

Also, the memory protocol engine 131-3 performs an operation of packetizing data and aligning, encoding, and decoding the packetized data to transmit the data to the CPU 110 using the packet communication method. For example, the memory protocol engine 131-3 packetizes the data (response data) read from the memory controller 131-4 according to the command data.

Meanwhile, when data retransmission is requested by the CPU 110 after the response data is transmitted to the CPU 110, the memory protocol engine 131-3 retransmits the previously transmitted response data to the CPU 110. For example, when command data received from the CPU 110 is the same as the command data which has been previously received from the CPU 110, the memory protocol engine 131-3 may determine that data retransmission is requested by the CPU 110.

When data retransmission is requested by the CPU 110, the memory protocol engine 131-3 retransmits a data packet which has been previously stored in the buffer 131-6 to the CPU 110. To this end, the memory protocol engine 131-3 may (temporarily) store the response data which has been previously transmitted to the CPU 110 in a retransmission buffer included in the buffer 131-6.

The memory controller 131-4 performs the corresponding operation according to the analysis result of the memory protocol engine 131-3. For example, when the analysis result of the memory protocol engine 131-3 indicates that the command data received from the CPU 110 is a write command, the memory controller 131-4 stores data included in the command data in the memory 131-5 (e.g., a storage element). When the analysis result of the memory protocol engine 131-3 indicates that the command data is a read command, the memory controller 131-4 reads data (response data) stored in the memory 131-5.

According to the exemplary embodiment of the present invention described above, even in a system including different kinds of memories, memory addresses seen from a CPU may be uniformized, basic calibration for accessing each of different kinds of memory modules is not necessary, and data exchanged between the CPU and the different kinds of memory modules and the number of control pins are reduced.

In addition, according to the exemplary embodiment of the present invention, a single high-speed serial link which does not require an additional interface (I/F) line for installation or removal of different kinds of memories is established, a memory channel of the CPU is simplified, and a memory connected to a switch is configured outside a mainboard, so that the memory can be connected through a high-speed serial link. Therefore, memory extension is facilitated.

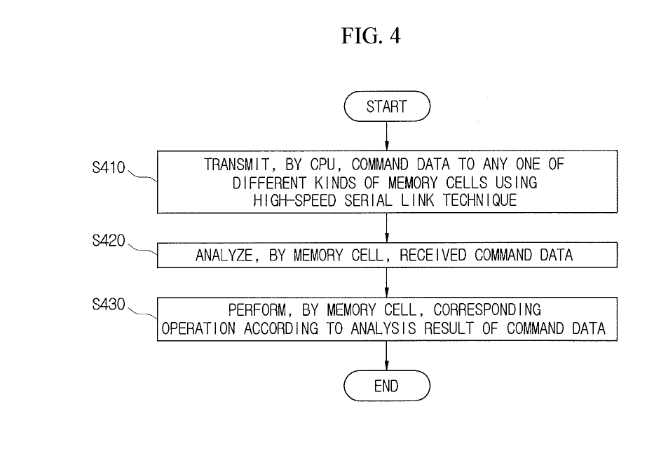

FIG. 4 is a flowchart illustrating a data communication method in a heterogeneous memory system according to an exemplary embodiment of the present invention.

The CPU 110 transmits command data to any one memory cell 131 among a plurality of memory cells (S410). At this time, the command data may be transmitted to the memory cell 131 through the switch 120 that is connected to the CPU 110 through one channel and connected to the respective plurality of memory cells using the high-speed serial link technique.

When the command data received from the CPU, the memory cell 131 analyzes the command data received from the CPU 110 (S420). For example, the memory cell 131 analyzes a packet of the command data as data, a command, an address, and so on.

The memory cell 131 performs the corresponding operation according to the analysis result of operation S420 (S430). For example, when the analysis result of operation S420 indicates that the received command data is a write command, the memory cell 131 stores data included in the command data in a storage element. When the analysis result of operation S420 indicates that the command data is a read command, the memory cell 131 reads data (response data) stored in the storage element.

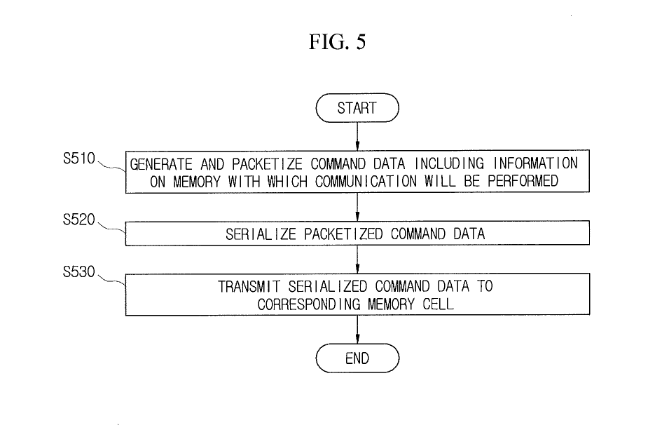

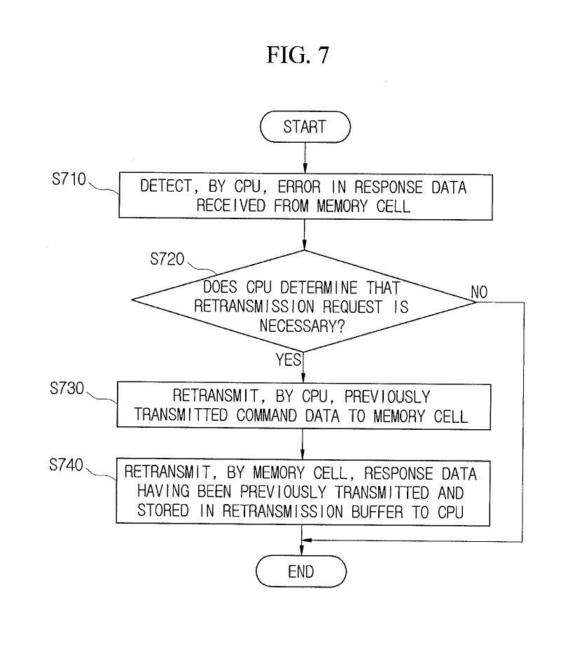

With reference to FIGS. 5 and 7, a data communication method between the CPU 110 and the memory cell 131 described in FIG. 4 will be described in detail below.

FIG. 5 is an operational flowchart of a CPU which generates and transmits command data in a heterogeneous memory system according to an exemplary embodiment of the present invention.

The CPU 110 generates and packetizes command data (S510). Here, the generated command data includes a command, data, and address information. For example, the CPU 110 generates command data including a command for the memory cell 131, data to be transmitted to the memory cell 131, and address information of the memory cell 131 to which the command or the data will be transmitted. The command data generated by the CPU 110 is transmitted to the memory cell 131 using the packet communication method, and to this end, the CPU 110 packetizes the generated command data.

The CPU serializes the packetized command data (S520). Here, the command data may be serialized by an interface IC implemented in the CPU 110.

The CPU 110 transmits the serialized command data to the memory cell 131 (S530). For example, the CPU 110 may transmit the command data using an optical element, such as an optical fiber, that supports high-speed communication.

In this process, the command data may be transmitted to the memory cell 131 through the switch 120. At this time, based on the address information included in the command data, the command data may be transmitted to the memory cell 131.

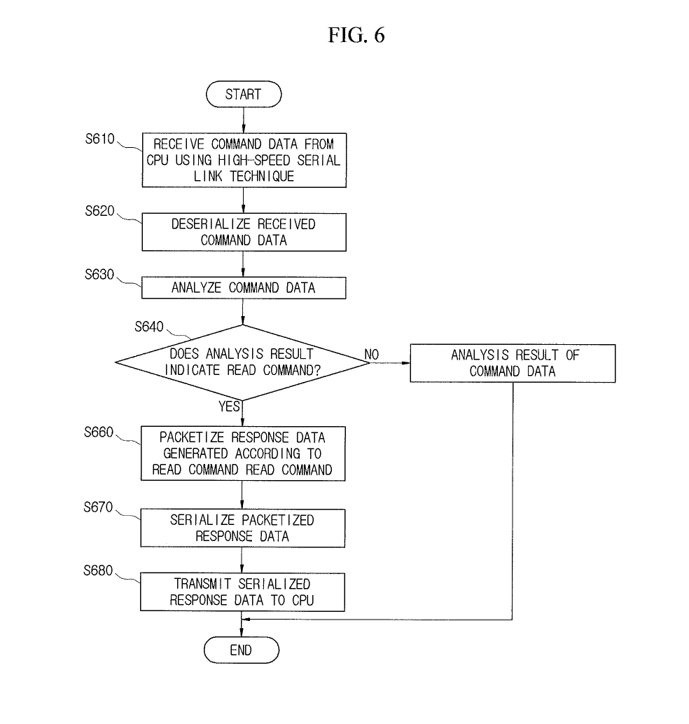

FIG. 6 is an operational flowchart of a memory cell which receives command data in a heterogeneous memory system according to an exemplary embodiment of the present invention.

The memory cell 131 receives the command data from the CPU 110 using the high-speed serial link technique (S610). For example, the memory cell 131 may receive the command data through the switch 120 using an optical element supporting high-speed communication, that is, an optical fiber.

The memory cell 131 deserializes the received command data (S620).

The memory cell 131 analyzes the deserialized command data (S630). For example, the memory cell 131 may divide the command data into a control signal and a data signal, and analyze the control signal as a command, such as a read command, a write command, or a delete command.

The memory cell 131 determines whether the analyzed command data is a read command (S640).

When the determination result of operation S640 indicates that the command data is not a read command, the memory cell 131 performs an operation corresponding to the command (S650). As an example, when the determination result indicates that the command data is a write command, the memory cell 131 stores data included in the command data in the storage element. At this time, in consideration of the address information included in the command data, the data may be stored in the corresponding address. As another example, when the determination result indicates that the command data is a delete command, the memory cell 131 deletes data stored in the storage element. At this time, in consideration of the address information included in the command data, only data stored in the corresponding address may be deleted.

When the determination result of operation S640 indicates that the command data is a read command, the memory cell 131 packetizes data (response data) read from the storage element (S660). At this time, in consideration of the address information included in the command data, the memory cell 131 may read data stored in the corresponding address as response data.

The memory cell 131 serializes the packetized response data to transmit the packetized response data to the CPU 110 (S670). For example, the response data may be serialized by an interface IC implemented in the memory cell 131.

The memory cell 131 transmits the serialized response data to the CPU 110 (S680). At this time, the response data may be transmitted to the CPU 110 through the switch 120.

In this process, the memory cell 131 may perform an operation corresponding to command data received from the CPU 110 and transmit response data corresponding to the command data to the CPU 110.

FIG. 7 is an operational flowchart of a CPU and a memory cell when a data retransmission request is generated in a heterogeneous memory system according to an exemplary embodiment of the present invention.

The CPU 110 detects an error in the response data received from the memory cell 131 (S710). For example, the CPU 110 may detect an error in the response data using an error detection algorithm, such as a data parity check code or a CRC code.

The CPU 110 determines whether or not data retransmission is necessary based on the error detection result (S720). For example, when it is not possible to correct the error in the received response data, the CPU 110 may determine that retransmission of the response data is necessary.

When the retransmission of the response data is necessary, the CPU 110 retransmits the previously transmitted command data to the memory cell 131 (S730). To this end, the command data that has been previously transmitted to the memory cell 131 may be temporarily stored at a predetermined position in the CPU 110.

The memory cell 131 requested to retransmit the response data by the CPU 110 retransmits the previously transmitted response data to the CPU 110 (S740). To this end, the response data that has been previously transmitted from the memory cell 131 to the CPU 110 may be temporarily stored at a predetermined position (e.g., a retransmission buffer) in the memory cell 131.

According to exemplary embodiments of the present invention, even in a system including different kinds of memories, memory addresses seen from a CPU can be uniformized, basic calibration for accessing each of different kinds of memory modules is not necessary, and data exchanged between the CPU and the different kinds of memory modules and the number of control pins are reduced.

According to exemplary embodiments of the present invention, a single high-speed serial link which does not require an additional I/F line for installation or removal of different kinds of memories is established, a memory channel of a CPU is simplified, and a memory connected to a switch is configured outside a mainboard, so that the memory can be connected through a high-speed serial link. Therefore, memory extension is facilitated.

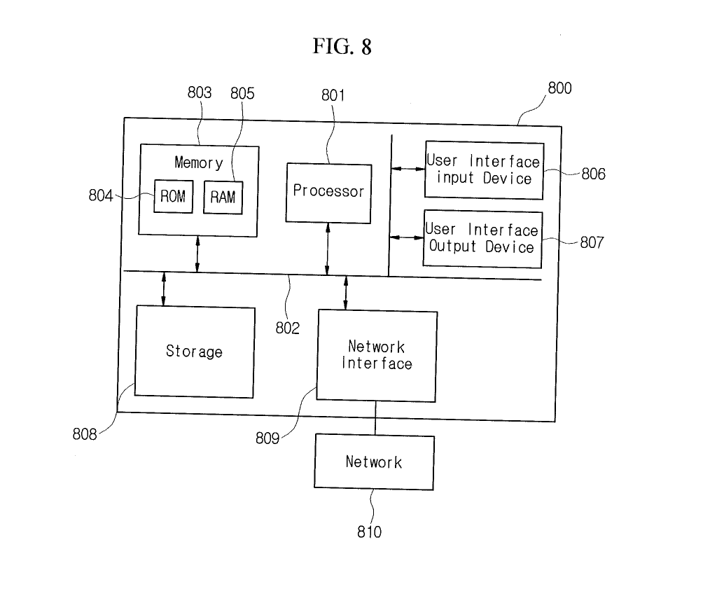

FIG. 8 is a block diagram illustrating a computer system for the present invention.

An embodiment of the present invention may be implemented in a computer system, e.g., as a computer readable medium. As shown in in FIG. 8, a computer system 800 may include one or more of a processor 801, a memory 803, a user input device 806, a user output device 807, and a storage 808, each of which communicates through a bus 802. The computer system 800 may also include a network interface 809 that is coupled to a network 810. The processor 801 may be a central processing unit (CPU) or a semiconductor device that executes processing instructions stored in the memory 803 and/or the storage 808. The memory 803 and the storage 808 may include various forms of volatile or non-volatile storage media. For example, the memory may include a read-only memory (ROM) 804 and a random access memory (RAM) 805.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A heterogeneous memory system comprising:
a plurality of different kinds of memory cells; and
a central processing unit (CPU) including a CPU protocol engine generating and packetizing command data to be transmitted to at least one of the plurality of memory cells, and configured to communicate with each of the plurality of memory cells using a high-speed serial link technique,
wherein each of the plurality of memory cells includes:
a memory protocol engine configured to analyze the command data received from the CPU; and
a memory controller configured to perform an operation according to an analysis result in the memory protocol engine.

2. The heterogeneous memory system of claim 1, further comprising a switch positioned among the plurality of memory cells and the CPU, connected to the CPU through one channel, and connected to the respective plurality of memory cells using the high-speed serial link technique,
wherein any one of the plurality of memory cells selectively performs data communication with the CPU through the switch.

3. The heterogeneous memory system of claim 1, wherein the CPU and each of the plurality of memory cells exchange data through a transceiver using optical communication.

4. The heterogeneous memory system of claim 1, wherein the command data includes commands for the respective plurality of memory cells, data to be transmitted to the respective plurality of memory cells, and address information of the plurality of memory cells to which the commands or the data will be transmitted.

5. The heterogeneous memory system of claim 1, wherein the CPU further including a CPU-side de/serializer configured to serialize the command data packetized by the CPU protocol engine and deserialize response data received from the at least one memory cell.

6. The heterogeneous memory system of claim 1, wherein the memory protocol engine divides the command data received from the CPU into a control signal and a data signal.

7. The heterogeneous memory system of claim 1, wherein, when the command data received from the CPU is a read command, the memory protocol engine packetizes response data to be transmitted to the CPU according to the read command.

8. The heterogeneous memory system of claim 7, wherein, when data retransmission is requested by the CPU, the memory protocol engine retransmits the response data having been previously transmitted and stored in a retransmission buffer to the CPU.

9. The heterogeneous memory system of claim 1, wherein each of the plurality of memory cells further includes a memory-side de/serializer configured to serialize data to be transmitted to the CPU and deserialize the command data received from the CPU.

10. A data communication method between a central processing unit (CPU) and any one memory cell among a plurality of different kinds of memory cells in a heterogeneous memory system in which each of the plurality of different kinds of memory cells and the CPU communicate using a high-speed serial link technique, the data communication method comprising:
transmitting, by the CPU, packetized command data to the one memory cell;
analyzing, by the memory cell, the received command data; and
performing, by the memory cell, an operation according to an analysis result of the command data.

11. The data communication method of claim 10, wherein the transmitting of the packetized command data by the CPU comprises transmitting, by the CPU, the packetized command data to the one memory cell through a switch positioned among the plurality of memory cells and the CPU, connected to the CPU through one channel, and connected to the respective plurality of memory cells using the high-speed serial link technique.

12. The data communication method of claim 10, further comprising generating, by the CPU, the command data including commands for the respective plurality of memory cells, data to be transmitted to the respective plurality of memory cells, and address information of the plurality of memory cells to which the commands or the data will be transmitted.

13. The data communication method of claim 11, wherein the transmitting of the packetized command data by the CPU comprises:
generating and packetizing the command data including information on the memory cell with which communication will be performed;
serializing the packetized command data; and
transmitting the serialized command data to the memory cell through the switch.

14. The data communication method of claim 10, wherein the analyzing of the received command data by the memory module comprises:
deserializing the command data received from the CPU; and
analyzing the deserialized command data to divide the deserialized command data into a control signal and a data signal.

15. The data communication method of claim 11, wherein the performing of the operation according to the analysis result by the memory module comprises:
when the analysis result indicates that the command data is a read command, packetizing response data read according to the read command;
serializing the packetized response data; and
transmitting the serialized response data to the CPU through the switch.

16. The data communication method of claim 10, further comprising:
detecting, by the CPU, an error in response data received from the memory module;
determining, by the CPU, whether or not it is necessary to receive the response data again according to a result of the error detection;
when it is determined that it is necessary to receive the response data again, retransmitting, by the CPU, the previously transmitted command data to the memory module; and
when the memory module receives the command data again, retransmitting the response data having been previously transmitted and then stored in a retransmission buffer to the CPU.
